(19) United States
(12) Patent Application Publication
(10) Pub. No.: US 2025/0209462 A1
(43) Pub. Date: Jun. 26, 2025

(54) SUSPICIOUS ACTIVITY DETECTION USING QUANTUM COMPUTER

(71) Applicant: International Business Machines Corporation, Armonk, NY (US)

(72) Inventors: Gregoire Hugues CATTAN, Krakow (PL); Filipe Joao Afonso Barroso, Medford, MA (US)

(21) Appl. No.: 18/380,799

(22) Filed: Oct. 17, 2023

(51) Int. Cl. G06Q 20/40; G06N 10/60

(52) U.S. Cl. CPC G06Q 20/4016; G06N 10/60

(57) ABSTRACT

Detecting anomalous transactions on quantum computers includes receiving a set of training data for training a machine learning model to predict an anomalous transaction. The set of training data is transformed into covariance matrices. The covariance matrices are transformed into vectors by slimming the covariance matrices by removing redundant elements of the covariance matrices and flattening the slimmed covariance matrices into the vectors. The vectors are input into the machine learning model, the machine learning model learning to predict whether a given transaction is anomalous. The machine learning model can be a quantum support vector machine configured to run on a quantum computer, and the vectors are converted to qubits, where control signals indicating quantum operations to apply the qubits in training the quantum support vector machine are transmitted to control quantum hardware of the quantum computer.

### BACKGROUND

The present application relates generally to computers and computer applications, and more particularly to anomalous or suspicious activity detection using covariance matrices and support vector machine for quantum computers and/or other classifiers.

### BRIEF SUMMARY

The summary of the disclosure is given to aid understanding of a computer system and method of anomalous or suspicious activity detection using covariance matrices and support vector machine for quantum computer and/or other classifiers, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

A computer-implemented method, in an aspect, includes receiving a set of training data for training a machine learning model to predict an anomalous transaction. The method also includes transforming the set of training data into covariance matrices. The method also includes transforming the covariance matrices into vectors by slimming the covariance matrices by removing redundant elements of the covariance matrices and flattening the slimmed covariance matrices into the vectors. The method also includes inputting the vectors into the machine learning model, the machine learning model learning to predict whether a given transaction is anomalous, for example, suspicious.

A system, in one aspect, include at least one computer processor. The system also includes at least one memory device coupled with the at least one computer processor. The at least one computer processor is configured to receive a set of training data for training a machine learning model to predict an anomalous transaction. The at least one computer processor is also configured to transform the set of training data into covariance matrices. The at least one computer processor is also configured to transform the covariance matrices into vectors by slimming the covariance matrices by removing redundant elements of the covariance matrices and flattening the slimmed covariance matrices into the vectors. The at least one computer processor is also configured to input the vectors into the machine learning model, the machine learning model learning to predict whether a given transaction is anomalous, for example, suspicious.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement anomalous or suspicious activity detection using quantum computer in some embodiments.

FIG. 2 is a diagram illustrating anomalous or suspicious activity detection using covariance matrices and support vector machine for quantum computer in some embodiments.

FIG. 3 shows an example of time series of covariance matrices in some embodiments.

FIG. 4 is a block diagram of an example system that uses quantum computer to detect anomalous transaction in some embodiments.

FIG. 5 illustrates a schematic of an example quantum computing system that may facilitate implementing anomalous activity or transaction in some embodiments.

FIG. 6 is a diagram showing components of a system in some embodiments that can facilitate detecting suspicious transactions, e.g., suspicious financial transactions.

FIG. 7 is a flow diagram illustrating a method of detecting anomalous transactions in some embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as anomalous or suspicious activity detection for quantum computer algorithm code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

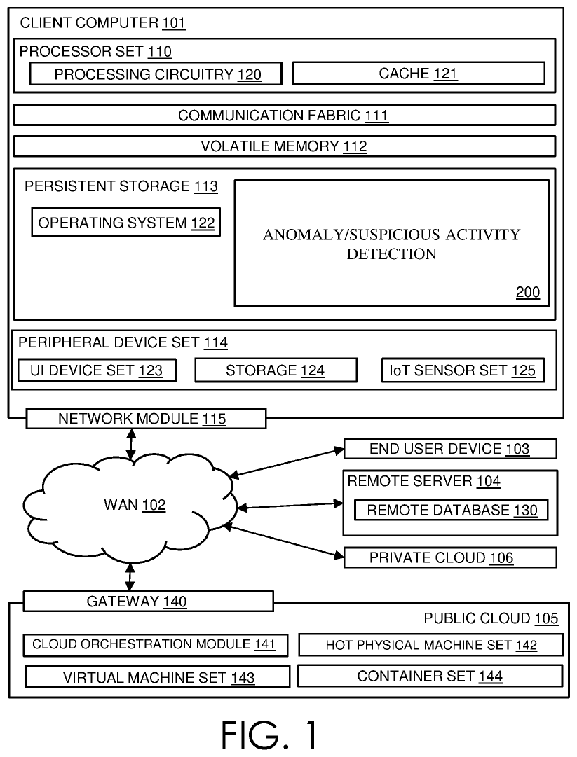

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows reading/writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Challenges of anomalous or suspicious activity detection include the identification of anomalous or suspicious activity patterns which involve multiples participants (e.g., collusion) and/or which occur over long period of time (e.g., suspicious branch agent). In some aspects, anomalous or suspicious activity patterns cause a different level of interaction between the dataset variables, and therefore a classification based on covariance information (covariance matrices) is relevant to detect anomalous or suspicious behaviors. Such classification is also computationally inexpensive, because its complexity only relies on the number of features (and not the number of samples).

In some embodiments, systems, methods and/or techniques include a design of an algorithm that is compatible with quantum classification, for example, for quantum computing on quantum computers and/or simulators, which have been identified as a major stack for financial activity such as portfolio optimization. Such an algorithm leverages classification of covariance matrices for financial data and quantum computing, even for quantum computers or machines, which are available for public use, that may have limited number of qubits (e.g., the number of features is 7) and limitation in leveraging quadratic optimization problem with continuous variables. Available quantum computers with higher number of qubit capabilities can produce higher noise, phenomenon known as quantum decoherence.

Use cases of systems and methods can include the following. In some embodiments, a system and/or method can be used in quantum technology and quantum information to classify between anomalous or suspicious transactions and genuine transactions, for example, in financial applications, based on transaction data and metadata, such as the transaction amount, categorical and unstructured variables such as country and/or the history of exchanges with the customer service. Using a method described herein that can preprocess data, large amounts of transaction data can be reduced to few bits of information for consumption by middleware or applications, including applications that run on quantum computers with limited number of qubits.

Transaction data can be transformed into covariance information. For example, a processor looks for covariance information between the transaction data or variables. For example, if the transaction data or variables considered include Internet Protocol (IP) and the country of origin, covariance information is obtained between those two types of transaction data or variables.

In some embodiments, a system and/or method use quantum technology to classify between suspicious and genuine agent based on the agent's audit log. For example, a bank agent closing an expected number of issues could be an indicator that this bank agent is colluded. This pattern may not be significative in a short period, but if longer period is considered, for example months or years, the covariance information could be different between a genuine versus suspicious agent.

In some embodiments, a system and/or method use quantum technology to classify between low and high risk based on some key performance indicators (KPIs) such as, but not limited to, loss or gain events.

In some embodiments, a system and/or method leverage categorical and/or unstructured data and can select the most suitable epoch length. The system and/or method vectorize the covariance matrices using a kind of half-vectorization, which keeps “half” of a matrix. Half-vectorization exploits the symmetric property of covariance matrices to only keep elements above or below the diagonal. Further dimension reduction can be performed by removing redundant elements in the matrix as described below. Then the covariance matrices are transformed into vectors to be used inside a support vector machine (SVM). For example, in some embodiments, the system and/or method vectorize the covariance matrices and classify the resulting feature vectors. The matrices are also half-vectorized, and the half removed. Half-vectorization may keep or remove the diagonal depending on a scenario.

A system and/or method can detect anomalous or suspicious financial transactions using quantum computing and/or quantum computers. An algorithm provided reduces sample data using a technique that flattens a matrix by removing one-half or more of the data points. For example, a type of half-vectorization, which exploits the symmetric property of the matrix, is performed. The algorithm includes removing the upper-left block, that is, the covariance matrix of the temporal class prototype, which is the same for all trials, and also includes optionally removing the diagonal of the matrix depending on the type of an estimator (for example, in correlation matrices, elements in the diagonal always have the value “1”). The system and/or method leads to data reduction for training and/or testing data to improve model generation as well as lowering the computational requirements to generate model(s). The system and/or method works with number of features, for example, not the number of samples, and hence has low computational complexity.

The system and/or method applies such matrix reduction to financial data including numeric data, categorical data (e.g., classes), and unstructured data (e.g., text, images). The system and/or method uses the covariance information between variables or features to detect financial anomalies. The algorithm is compatible with Riemannian geometry. For example, the system and/or method can use Riemannian geometry, a suitable space for dimension reduction of covariance matrices. Such dimension reduction may be used to further refine training and/or testing data. In some embodiments, the system and/or method can run or be implemented on classical computers, quantum computers, and/or simulators, where the pre-processing of the data can remain untouched regardless of which type of platform or computer is used.

In some embodiments, a method and/or system computes covariance matrices as follows.
1) Compute the Euclidian mean of all anomalous or suspicious activity epochs (mean anomalous or suspicious activity). For example, each epoch has M variables or features (e.g., IP, Country of origin, etc.) and T time-samples. The method and/or system in some embodiments uses supervised classification, and therefore, provide labeled data of suspicious and genuine (non-suspicious) activity. For example, there are K epochs labeled with suspicious activity (referred to as TA (target activity) for targets), and L epochs labeled with genuine activity (referred to as NT (non-target) for non-targets). Thus, in this example, there are two sets of data: KxMxT (i.e., K multiplied by M multiplied by T) for target (TA) and LxMxT for non-target (NT). The method and/or system in some embodiments computes the Euclidian mean of all epochs inside the target set: MeanTA has size MxT. This can be referred to as a “prototype” of what looks like a suspicious activity epoch.
2) For each epoch, concatenate vertically the epoch with mean anomalous or suspicious activity (also referred to as MeanTA). For example, there are: KxMxT samples for target (TA); LxMxT samples for non-target (NT); and one mean, MeanTA. The system and/or method concatenates each epoch with MeanTA. For example, the system and/or method takes a target epoch of size M×T, and adds at the bottom (or end) of it the MeanTA. This results in a “super epoch” with 2M variables and T samples.
3) Compute the covariance matrix of the concatenated epoch. If X is a concatenated epoch, then the system and/or method compute the covariance matrix as follows: X*transpose (X). The size of this covariance matrix is 2M×2M, which does not depend on the number of trials. This is referred to as “super-trial.” Super-trial can be split into 4 blocks: the upper-left block contains the covariance of MeanTA with MeanTA, which is the same for all super-trials; the bottom-right block contains the covariance of the epoch with itself, which is specific to an epoch; the two other blocks are symmetric and contain the covariance of the epoch with MeanTA.

Optionally, the system and/or method reduces the dimensionality of the covariance matrices, e.g., compatible with Riemannian geometry, e.g., whitening that makes features less correlated with each other, less redundant, and denser. This can be an optional unsupervised dimension reduction with symmetric positive definite (SPD) matrices as inputs. Covariance matrices are SPD matrices.

A system and/or method extracts samples over a time period (e.g., which can be predefined, e.g., 3 days, weeks, months, year, or another time period) to identify a time period range to build covariance matrices.

A system and/or method vectorizes covariance matrices by keeping only non-redundant information. This vectorization technique includes the following processing:
1) A covariance matrix being symmetric, remove all elements either above or below the diagonal;
2) Remove the upper-left quadrant of the matrix as it is the covariance matrix of the mean anomalous or suspicious activity and this information is the same for all covariance matrices.
3) Optionally remove the diagonal of the matrix (that is, the covariance of a variable with itself for all variables). In particular, when using a correlation matrix, the diagonal contains only ones.

A system and/or method encodes unstructured data into structured data, using known or existing techniques such as: case based-analysis; image analysis (identifying picture element and labeling); and text mining.

A system and/or method encodes categorical data into numerical variables (e.g., OneHotEncoder). In some embodiments, a system and/or method reduces the dimensionality of the epochs (e.g., using singular value decomposition (SVD), xDAWN algorithm which is a spatial filter) prior to calculating covariance matrices.

A system and/or method estimates hyperparameters for the model, for example, with classical support-vector machine/Linear Discriminant Analysis (LDA). In some embodiments, hyperparameters are: the length of the time-period; the estimator used for covariances matrices; a Boolean value which says whether or not the system and/or method keeps the diagonal of the covariance matrices in flattening the covariance matrices.

A quantum-enhanced support vector classifier can use the pre-processed data, e.g., the flattened covariance matrices. Examples of such classifier include quantum support vector classifier (QSVC), which may be inside a library of quantum circuits used for machine learning applications and machine learning algorithms. The QSVC can run either on a simulator backend or real quantum computer backend. It can also be replaced by a standard SVC or LDA without other modification in the pipeline.

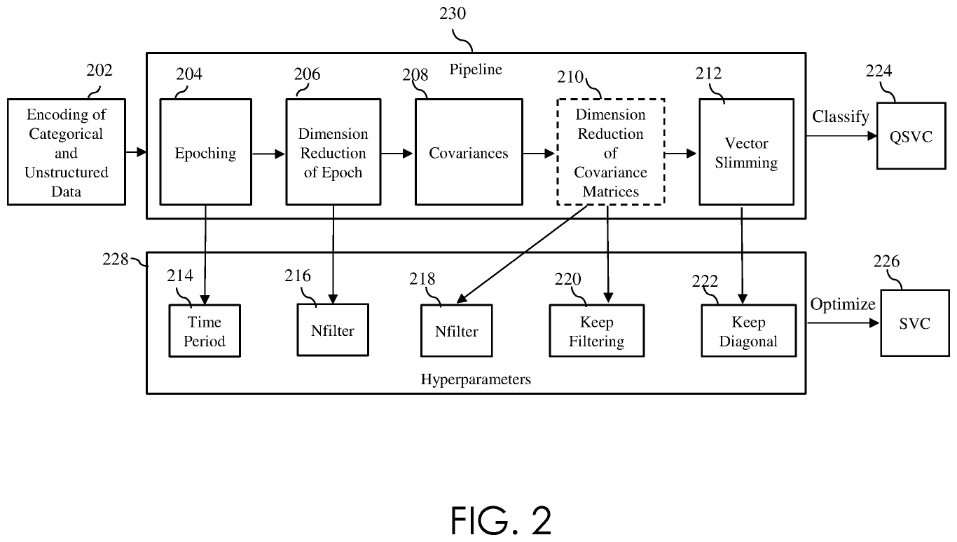

FIG. 2 is a diagram illustrating anomalous or suspicious activity detection using covariance matrices and support vector machine for quantum computer in some embodiments. One or more computer processors, for example, described above with reference to FIG. 1 can perform such anomalous or suspicious activity detection, for example, by machine learning classification using covariance matrices described herein. A system and/or method described herein allows for such machine learning classification to be performed on a quantum computer. A processor, for example, reduces data amount used in machine learning classification to a few number of features, for example, 5-7 features such that a quantum computer even with a limited number of qubits can be used in running a machine learning classification algorithm. Data reduction processing described herein can also be used or consumed by any existing or future middleware.

A processor, for example, receives or obtains transaction data (e.g., also referred to as variables), for example, 3 variables: the amount of the transaction, country of a customer (or country of origin of the transaction), and history of exchanges with a customer service. If the transaction data or variables are being used for training a machine learning model, the variables are labeled, that is, the variables have corresponding ground truth labels.

At 202, a processor encodes the received data, which can include categorical data and unstructured data. For example, a processor uses a one-hot encoder to transform the country of residence (categorical data) into a numerical value, and performs sentiment analysis on the customer client history (unstructured text data) for “negative” feeling which rates in the range from 1 to 5 for low to strong antipathy. The amount of the transaction is numerical, so in this example, additional encoding need not be performed. Categorical data, for example, has a finite number of categories. Unstructured data can be text, video, or natural language. Encoding transforms the transaction data that are non-numerical form into numeric values or numbers.

At 204, epoching is performed. Epoching obtains a time period 214 (e.g., time window or time frame) for using the received transaction data. For example, the received transaction data for that time period 214 would be considered for processing. This time period 214 is configurable and is a hyperparameter that is optimized or learned using an optimization technique, e.g., a machine learning technique such as a support vector machine 226. For example, a processor extracts the values of these attributes or variables (received data some of which is encoded at 202) within a number of (e.g., 3) different time periods: e.g., 3 days, 3 weeks and 3 months. For instance, the time period is a parameter of pipeline 230. The pipeline 230 can be optimized using optimization such as a grid search.

At 206, dimension reduction of epoch is performed. For example, dimension reduction is performed on the original epochs of size M×T. Existing dimension reduction such as principal component analysis (PCA), variable selection algorithm can be used to reduce the number of variables. For example, the system and/or method can select the variables that explain a threshold amount, e.g., 80% of the model variance. This threshold can be predefined. In another embodiment, a threshold can indicate a specific number of variables desired to be kept. The remaining variables are then a linear combination of all the variables that maximizes the feature-to-noise ratio. Such threshold can be predefined. Hyperparameter nfilter 216 specifies the number of dimension or features the variables should be reduced to, and is configurable. For example, nfilter 216 can be optimized or learned using an optimization technique, e.g., a machine learning technique such as a support vector machine 226.

At 208, a processor transforms all epochs into covariance matrices. For example, covariance matrix is created for the variables or features remaining after the dimension reduction performed at 206. Briefly, covariance matrix represents the covariance values between pairs of elements in a data set. Variance is a measure of spread of data from the mean of the data set. Covariance is computed between two variables and is used to measure how the two variables vary together. The diagonal elements of a covariance matrix represent the variance and the off-diagonal elements represent the covariance. By way of example, the covariance between two variables can be positive, negative, and zero, where a positive covariance indicates that the two variables have a positive relationship, negative covariance shows that they have a negative relationship, and zero covariance indicates that the two variables do not vary together. Covariance matrices generated at 208 include the covariance of an epoch of data with the mean epoch of all suspicious epochs. For example, a processor takes a piece of data and computes a “similarity” to a prototype of suspicious behavior.

In some embodiments, the following processing is performed to transform epochs into covariance matrices: a) Compute the mean covariance matrices for anomalous or suspicious transactions (anomalous or suspicious activity prototype); b) Concatenate to each time epoch the anomalous or suspicious activity prototype (super-trial); c) Take the covariance matrices of the super-trial.

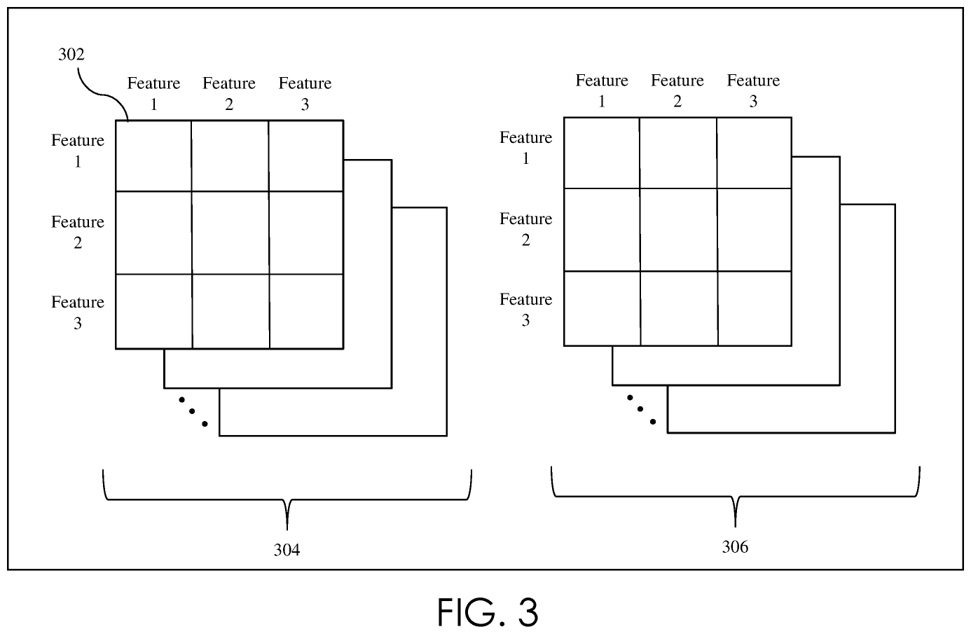

For example, a prototype can be built as follows. Covariance matrices of anomalous or suspicious transaction data and covariance matrices of normal or genuine (non-anomalous or not suspicious) transaction data can be generated for specific time periods (epochs), resulting in two sets of covariance matrices. FIG. 3 shows an example of covariance matrices built on time series. For example, a covariance matrix 302 has rows and columns representing the variables of features (transaction data). Covariance matrices are built with anomalous or suspicious transaction data, as shown at 304. Similarly, a set of covariance matrices are built with normal or genuine (non-anomalous or not suspicious) transaction data as shown at 306. Thus, at 208, a prototype for anomalous or suspicious activity that includes a set of covariance matrices 304, and a prototype for normal activity that includes a set of covariance matrices 306 are built. The two sets (304, 306) of covariance matrices are built over the time period specified by the hyperparameter 214. One epoch is transformed into one covariance matrix, also known as a super-trial. For example, as described above, if X is a concatenated epoch, the covariance matrix can be computed as follows: X*transpose (X). The size of this covariance matrix is 2M×2M. This is referred to as “super-trial.” Super-trial can be split into 4 blocks: the upper-left block contains the covariance of MeanTA with MeanTA, which is the same for all super-trials; the bottom-right block contains the covariance of the epoch with itself, which is specific to an epoch; the two other blocks are symmetric and contain the covariance of the epoch with MeanTA.

During prediction, responsive to receiving a new covariance matrix for classification as either suspicious or normal, the two prototypes can be used in machine learning (e.g., quantum support vector machine) to classify or predict whether the new covariance matrix represents suspicious transaction or normal transaction.

Optionally at 210, a processor uses an existing or known dimensionality reduction technique based on Riemannian Geometry, such whitening, to lower the dimension of the covariance matrices, e.g., reduce the size of the covariance matrices. For example, hyperparameter 220 (e.g., named keep filtering) determines whether this dimensional reduction of covariance matrices should be performed. Hyperparameter 218 (e.g., named nfilter) specifies the number of dimensions to reduce to. These hyperparameters 218 and 220 can be configured and learned during optimization using an optimization technique, (e.g., a grid search cross-validation (cv), random search cv) 226.

At 212, a processor transforms all covariance matrices, for example, with their dimensions reduced, to slim vectors. For instance, covariance matrices are transformed into vector forms for feeding into a support vector machine. Covariance matrices are symmetric. Since a covariance matrix is symmetric, in some embodiments, only one half of the matrix need to be kept. In some embodiments, a diagonal of the covariance matrix also can be removed. In some embodiments, the upper-left block can also be removed, as it is redundant across all covariance matrices. For example, in the case of a correlational matrix, information of the diagonal might not be relevant, and hence, need not be kept. Hyperparameter 222 that specifies whether to keep the diagonal of the covariance matrix (named keep diagonal by way of example) can be configured and learned using an optimization technique, e.g., a machine learning technique such as a support vector machine 226. The remaining values of the covariance matrix (e.g., left-lower half below the diagonal (or right-upper half above the diagonal) are transformed into a vector by flattening it. For example, remaining elements of a covariance matrix are wrapped around into a vector (e.g., one-dimensional array form), e.g., starting from top row going across the columns, then next row across the columns and so forth to the last row. This is done for all covariance matrices for the two sets of prototypes, which results in a set of vectors for anomalous transaction prototype and another set of vectors for normal transaction prototype.

At 224, a processor trains a classifier using the slimmed vectors, which include labeled data. In some embodiments, this classifier is a quantum computer classifier such as a quantum support vector classifier or machine (QSVC).

A processor optimizes at 226 the hyperparameters 228 (for example, 214, 216, 218, 220, 222) of the classifier 224 on another set of labeled data. For example, there can be additional data set for parameter optimization. Optimizing hyperparameters 228 determines which time period 214 is the best (3 days, weeks or months) for epoching 204, number of filters 216 for dimension reduction of epochs 206, number of filters 218 for dimension reduction of covariance matrices 210, a keep filtering hyperparameter 220 that indicates whether a processor needs to perform the dimension reduction at 210, and a keep diagonal hyperparameter 222 that indicates whether a diagonal of the covariance matrix should be kept or removed during vector slimming 222. An example of an optimizer or optimization technique a processor uses is a support vector classifier or machine (QVC) 226. In some embodiments, a classical computer can be used to run an optimization (e.g., support vector classifier or machine (QVC) 226) for optimizing the hyperparameters 228. The hyperparameters 228 are optimized together, e.g., simultaneously. An instance of pipeline 230 can be created using hyperparameters 228 fitted to the data used in optimizing the hyperparameters.

Example code snippet which can be used to perform vector slimming 212 is shown below.

• Vector slimming example implementation in python
• ----------------------------------------------------------------------------------
• import numpy as np.
// x is a covariance matrix
• def slim(x):
• l = len(x) // 2
• first = range(0, l)
• last = range(len(x) − l, len(x))
• down_cadrans = x[np.ix_(last, last)]
// consider using i <= j if keeping the diagonal is wanted.
• down_cadrans = [down_cadrans[i, j] for i in first for j in first if i < j]
• first_cadrans = np.reshape(x[np.ix_(last, first)], (1, len(x)))
• ret = np.append(first_cadrans, down_cadrans)
• return ret

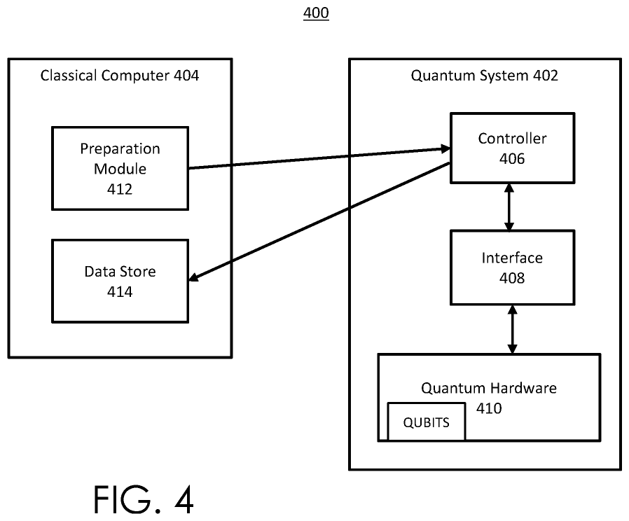

FIG. 4 is a block diagram of an example system that uses quantum computer to detect anomalous transaction in some embodiments. System 400 can facilitate processing of a quantum algorithm such as a quantum support vector machine or classifier (e.g., QSVM or QSVC). System 400 can be a hybrid computing system including a combination of one or more quantum computers, quantum systems, and/or classical computers. In an example shown in FIG. 4, system 400 can include a quantum system 402 and a classical computer 404. In an embodiment, quantum system 402 and classical computer 404 can be configured to be in communication via one or more of wired connections and wireless connections (e.g., a wireless network). Quantum system 402 can include a quantum chipset that includes various hardware components for processing data encoded in qubits. The quantum chipset can be a quantum computing core surrounded by an infrastructure to shield the quantum chipset from sources of electromagnetic noise, mechanical vibration, heat, and other sources of noise, which tend to degrade performance. Classical computer 404 can be electronically integrated, via any suitable wired and/or wireless electronic connection, with quantum system 402.

In the example shown in FIG. 4, quantum system 402 can be any suitable set of components capable of performing quantum operations on a physical system. A quantum operation can be, for example, a quantum gate operation that manipulate qubits to interact with one another in accordance with the quantum gate operation. In a gate-based quantum system, such quantum gate operations can implement a quantum circuit. For example, a quantum circuit can include a sequence of quantum gate operations on one or more selected qubits. In an embodiment, quantum system 402 can include a controller 406, an interface 408, and quantum hardware 410. In some embodiments, all or part of each of controller 406 (e.g., a local classical controller), interface (e.g., a classical-quantum interface) 408, and quantum hardware 410 can be located in a cryogenic environment to aid in the performance of the quantum operations. Quantum hardware 410 may be any hardware capable of using quantum states to process information. Such hardware may include a plurality of qubits and mechanisms to couple/entangle qubits in order to process information using the quantum states. A qubit can be implemented as a physical device. Examples of physical implementation of a qubit can include, but not limited to, a superconducting qubit, a trapped ion qubit, and/or others. Qubits may include, but are not limited to, charge qubits, flux qubits, phase qubits, spin qubits, and trapped ion qubits. Quantum computations can be performed by applying various quantum gates (e.g., for gate-based systems) or other operations on one or more qubits or qubit states to result in quantum states of the qubits. Quantum gates can include one or more single-qubit gates, two-qubit gates, and/or other multi-qubit gates. For example, quantum hardware 410 can be configured to perform quantum gate operations or other operations on qubits.

Controller 406 can be any combination of digital computing devices capable of performing a quantum computation, such as executing a quantum circuit which may model or specify quantum operations or quantum gate operations, in combination with interface 408. Such digital computing devices may include digital processors and memory for storing and executing quantum commands using interface 408. Additionally, such digital computing devices may include devices having communication protocols for receiving such commands and sending results of the performed quantum computations to classical computer 404. Additionally, the digital computing devices may include communications interfaces with interface 408. In an embodiment, controller 406 can be configured to receive classical instructions (e.g., from classical computer 404) and convert the classical instructions into commands (e.g., command signals) for interface 408. Command signals being provided by controller 406 to interface 408 can be, for example, digital signals indicating quantum gates or other quantum operations to apply to qubits 104 to perform a specific function (e.g., machine learning). Interface 408 can be configured to convert these digital signals into analog signals (e.g., analog pulses such as microwave pulses) that can control the quantum hardware 410, e.g., to have one or more quantum gates or other operations act on one or more qubits to manipulate interactions between qubits.

Interface 408 can be a classical-quantum interface including a combination of devices capable of receiving commands or command signals from controller 406 and converting those commands or command signals into quantum operations for implementing on quantum hardware 410. In an embodiment, interface 408 can convert the commands from controller 406 into drive signals that can drive quantum hardware 410, e.g., manipulate qubits, e.g., control quantum gate operations on qubits. Additionally, interface 408 can be configured to convert signals received from quantum hardware 410 into digital signals capable of processing and transmitting by controller 406 (e.g., to classical computer 404). Devices included in interface 408 can include, but are not limited to, digital-to-analog converters, analog-to-digital converters, waveform generators, attenuators, amplifiers, optical fibers, lasers, and filters. Interface 408 can further include circuit components configured to measure a basis of the plurality of qubits following the implementation of quantum gates, where the measurement will yield a classical bit result. For example, a basis of |0) corresponds to classical bit zero, and a basis of |1) corresponds to classical bit one. Each measurement performed by interface 408 can be read out to a device, such as classical computer 404, connected to quantum system 402. A plurality of measurement results provided by interface 408 can result in a probabilistic outcome.

Classical computer 404 can include hardware components such as processors and storage devices (e.g., including memory devices and classical registers) for processing data encoded in classical bits. In one embodiment, classical computer 404 can be configured to control quantum system 402 by providing various control signals, commands, and data encoded in classical bits to quantum system 402. Further, quantum states measured by quantum system 402 can be read by classical computer 404 and classical computer 404 can store the measured quantum states as classical bits in classical registers. In an embodiment of an implementation, classical computer 404 can be any suitable combination of computer-executable hardware and/or computer-executable software capable of executing a preparation module 412 to perform quantum computations with data stored in data store 414 as part of building and implementing a machine learning protocol. Data store 414 may be a repository for data to be analyzed using a quantum computing algorithm, as well as the results of such analysis. Preparation module 412 may be a program or module capable of preparing classical data from data store 414 to be analyzed as part of the implementation of a quantum circuit. Preparation module 412 may be instantiated as part of a larger algorithm, such as a function call of an application programming interface (API) or by parsing a hybrid classical-quantum computation into aspects for quantum and classical calculation. Preparation module 412 may generate instructions for creating a quantum circuit using quantum gates. In an embodiment, such instructions may be stored by controller 406, and may instantiate the execution of the components of interface 408 so that the quantum operations of the quantum gates may be performed on quantum hardware 410.

Components of classical computer 404 are described in more detail above with reference to FIG. 1. In an example system, classical computer 404 can be a laptop computer, a desktop computer, a vehicle-integrated computer, a smart mobile device, a tablet device, and/or any other suitable classical computing device. Additionally or alternatively, classical computer 404 may also operate as part of a cloud computing service model, such as Software as a Service (Saas), Platform as a Service (PaaS), or Infrastructure as a Service (IaaS). Classical computer 404 may also be located in a cloud computing deployment model, such as a private cloud, community cloud, public cloud, or hybrid cloud.

System 400 can implement a quantum computer suspicious transaction or activity detection, for example, in financial transactions in computer systems or networks such as banking systems. System 400, for example, can implement quantum support vector machine (QSVM) or classifier (QSVC) that can take pre-processed data as described herein and predict, classify or detect suspicious transactions.

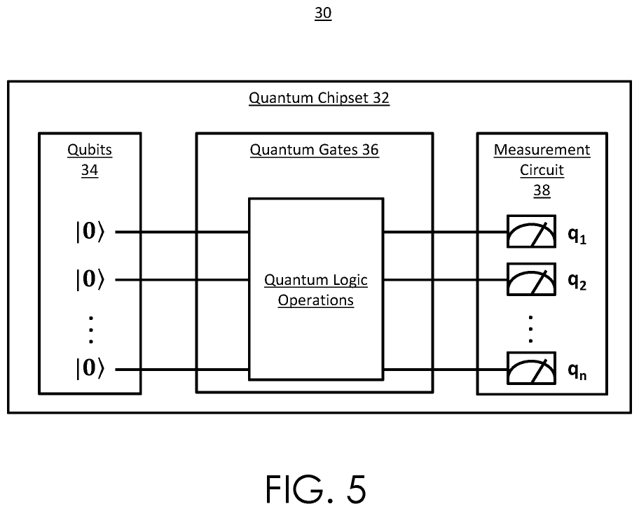

FIG. 5 illustrates a schematic of an example quantum computing system that may facilitate implementing anomalous activity or transaction in some embodiments. For example, a system facilitates detecting suspicious financial transactions in computer networks in some embodiments. Quantum computing system 30 can be implemented by a quantum system shown at 402 in FIG. 4. Quantum computing system 30 can include a quantum chipset 32. Quantum chipset 32 can include one or more components configured to operate on a plurality of qubits 34. For example, a quantum circuit can be implemented by components of the quantum chipset 32. In an aspect, qubits 34 can be arranged in a two-dimensional or three-dimensional array, such as being arranged in a lattice structure. A two-dimensional qubit array can be formed on a surface of a two-dimensional wafer, and the qubits 34 can be arranged in a two-dimensional lattice structure and configured to communicate with one another. A three-dimensional device array can be formed by a stack of two-dimensional wafers, and qubits 34 can be arranged in a three-dimensional lattice structure and configured to communicate with one another via connections between the two-dimensional wafers.

Quantum chipset 32 can be a quantum computing core surrounded by an infrastructure to shield quantum chipset 32 from sources of electromagnetic noise, mechanical vibration, heat, and other sources of noise, which tend to degrade performance. Magnetic shielding can be used to shield the system components from stray magnetic fields, optical shielding can be used to shield the system components from optical noise, thermal shielding and cryogenic equipment can be used to maintain the system components at controlled temperature, etc. For example, an infrastructure that can surround quantum chipset 32 can be a refrigerator that can cool the quantum chipset to an operating temperature of quantum chipset 32.

In the figure, the plurality of qubits can be denoted as q1, q2 . . . , qn. Quantum chipset 32 can operate by performing quantum logic operations (e.g., using quantum gates 36) on qubits. Quantum gates 36 can include one or more single-qubit gates and/or two-qubit gates. Quantum circuits can be formed based on quantum gates 36, and quantum chipset 32 can operate the quantum circuits to perform quantum logic operations on single qubits or conditional quantum logic operations on multiple qubits. Conditional quantum logic can be performed in a manner that entangles the qubits. Control signals can be received by quantum chipset 32, and quantum chipset 32 can use the received control signals to manipulate the quantum states of individual qubits and the joint states of multiple qubits.

Measurement interface 38 can include circuit components configured to measure a basis of qubits 34, where the basis is a measurement that will yield a classical bit result. Each measurements performed by measurement interface circuit 38 can be read out to a device (e.g., a classical computer) connected to quantum computing system 30. A plurality of measurement results provided by measurement circuit 38 can result in a probabilistic outcome.

Systems and methods described herein can also run on other types of quantum computers, e.g., not limited to those described with reference to FIGS. 4 and 5.

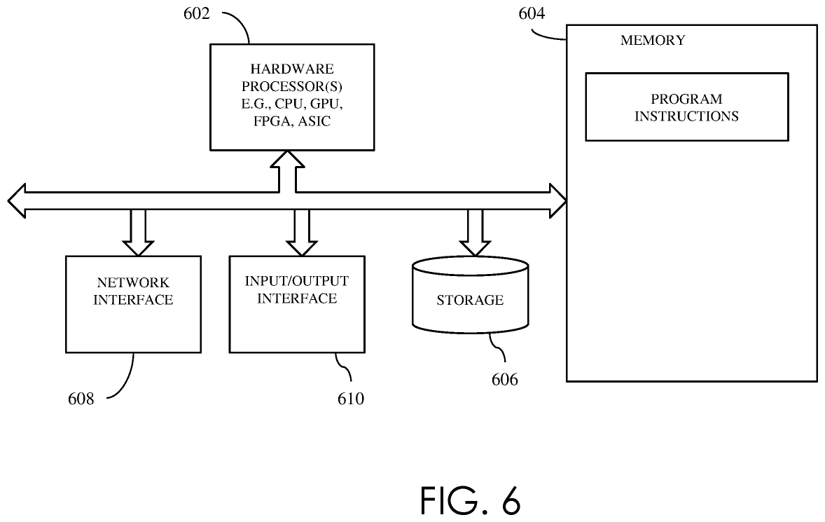

FIG. 6 is a diagram showing components of a system in some embodiments that can facilitate detecting suspicious transactions, e.g., suspicious financial transactions. One or more hardware processors 602 such as a central processing unit (CPU), a graphic process unit (GPU), and/or a Field Programmable Gate Array (FPGA), an application specific integrated circuit (ASIC), and/or another processor, may be coupled with a memory device 604, and facilitate detection of anomalous transactions or activity, e.g., in financial computer networks or systems. For example, data pre-processed by one or more hardware processors 602 can be fed to a quantum computer for the quantum computer to perform machine learning and detect anomalous transactions. A memory device 604 may include random access memory (RAM), read-only memory (ROM) or another memory device, and may store data and/or processor instructions for implementing various functionalities associated with the methods and/or systems described herein. One or more processors 602 may execute computer instructions stored in memory 604 or received from another computer device or medium. A memory device 604 may, for example, store instructions and/or data for functioning of one or more hardware processors 602, and may include an operating system and other program of instructions and/or data. One or more hardware processors 602 may receive a set of training data for training a machine learning model to predict an anomalous transaction. One or more hardware processors 602 may transform the set of training data into covariance matrices. One or more hardware processors 602 may transform the covariance matrices into vectors by slimming the covariance matrices by removing redundant elements of the covariance matrices and flattening the slimmed covariance matrices into the vectors. One or more hardware processors 602 may input the vectors into the machine learning model, the machine learning model learning to predict whether a given transaction is anomalous. In one aspect, data used by one or more hardware processors 602 may be stored in a storage device 606 or received via a network interface 608 from a remote device, and may be temporarily loaded into a memory device 604 for processing. One or more hardware processors 602 may be coupled with interface devices such as a network interface 608 for communicating with remote systems, for example, via a network, and an input/output interface 610 for communicating with input and/or output devices such as a keyboard, mouse, display, and/or others.

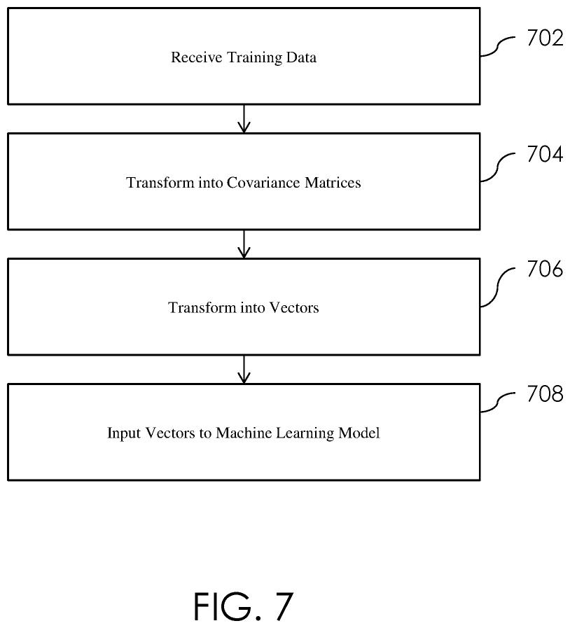

FIG. 7 is a flow diagram illustrating a method of detecting anomalous transactions in some embodiments. The method can be performed by one or more computer processors, for example, described above with reference to FIG. 2, FIGS. 4-6. At 702, a set of training data is received for training a machine learning model to predict an anomalous transaction. For example, a number of features can be received related to computer transactions such as online financial transactions.

At 704, the set of training data is transformed into covariance matrices. Covariance matrices are also referred to as super-trials, as described above. For instance, elements of the diagonal of a covariance matrix represent covariance of a feature with itself, for all features. Non-diagonal elements represent covariance between a pair of features.

At 706, the covariance matrices are transformed into vectors by slimming the covariance matrices by removing redundant elements of the covariance matrices and flattening the slimmed covariance matrices into the vectors, for example, as described above with reference to FIG. 2.

At 708, the vectors are input into the machine learning model, the machine learning model learning to predict whether a given transaction is anomalous.

In an aspect, the preparation of the data in the manner described leads to less computations for the classification algorithm. For example, a single epoch of size M*T is reduced to a covariance of size 2M*2M then a vector containing maximum 2M*2M/2 elements.

In some embodiments, the machine learning model is a quantum support vector machine running on a quantum computer, and the vectors are converted to qubits, where control signals indicating quantum operations to apply the qubits in training the quantum support vector machine are transmitted to control quantum hardware of the quantum computer.

In other embodiments, the vector can be applied to all classifiers using vector, such as variational quantum classifier which is a type of neural network.

In some embodiments, the method also include receiving a new data sample, transforming the new data sample into a covariance matrix, transforming the covariance matrix into a vector by slimming the covariance matrix by removing redundant elements of the covariance matrix and flattening the slimmed covariance matrix into the vector, and inputting the vector into the quantum computer for the trained quantum support vector machine to classify whether the new data sample is anomalous. For example, the vectors are converted to qubits, and control signals are sent to quantum hardware of the quantum computer to control the quantum hardware to perform quantum operations for predicting whether the new data sample is anomalous.

In some embodiments, the method includes, responsive to determining that the set of training data includes unstructured data, encoding the unstructured data into numerical data prior to transforming the set of training data into covariance matrices.

In some embodiments, the method includes, responsive to determining that the set of training data includes categorical data, encoding the categorical data into numerical data prior to transforming the set of training data into covariance matrices.

In some embodiments, the method includes, the set of training data includes time series data, and the method includes sampling the set of training data over a time period, where the time period is a hyperparameter that is learned using a classical support vector machine and used in a pipeline for pre-processing the set of training data for training of a quantum support vector machine on a quantum computer.

In some embodiments, the slimming of the covariance matrices by removing redundant elements of the covariance matrices includes removing an upper half of the covariance matrices above diagonals of the covariance matrices.

In some embodiments, the slimming of the covariance matrices by removing redundant elements of the covariance matrices includes removing the upper left block of the covariance matrices.

In some embodiments, the slimming of the covariance matrices by removing redundant elements of the covariance matrices further includes determining whether to remove the diagonals of the covariance matrices based on a hyperparameter that is learned using a classical support vector machine and used in a pipeline for pre-processing the set of training data for training of a quantum support vector machine on a quantum computer.

For example, one or more of the following elements of the covariance matrices can be removed: the upper-left block (since it can be considered useless as it is the same for all covariance matrices); anything above the diagonal (because the matrix is symmetric, this constitutes a duplicate of what is below the diagonal); and optionally the diagonal.

In some embodiments, the method includes, performing dimension reduction of the covariance matrices, where the dimension reduction is performed based on a hyperparameter that is learned using a classical support vector machine and used in a pipeline for pre-processing the set of training data for training of a quantum support vector machine on a quantum computer, the hyperparameter indicating whether the dimension reduction should be performed.

In some embodiments, another hyperparameter representing a number of dimensions to which the covariance matrices is to be reduced is learned using a classical support vector machine and used in a pipeline for pre-processing the set of training data for training of a quantum support vector machine on a quantum computer, the hyperparameter indicating whether the dimension reduction should be performed. This can also be considered as an optimization depending on the situation, as the choice of the hyperparameter can be done in a classical way. In this way, queuing time can be avoided when starting multiple processes in the quantum computer.

In some embodiments, the set of training data includes financial transactions or activities performed on systems such as banking systems. In some embodiments, the new sample data includes financial transaction or activity data perform on systems such as banking systems.

A system including at least one computer processor and at least one memory device coupled with the at least one computer processor is also disclosed, where the at least one computer processor is configured to perform one or more methods described above. A computer program product is also disclosed that includes a computer readable storage medium having program instructions embodied therewith, where the program instructions are readable by a device to cause the device to perform one or more methods described above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving a set of training data for training a machine learning model to predict an anomalous transaction;
transforming the set of training data into covariance matrices;
transforming the covariance matrices into vectors by slimming the covariance matrices by removing redundant elements of the covariance matrices and flattening the slimmed covariance matrices into the vectors; and
inputting the vectors into the machine learning model, the machine learning model learning to predict whether a given transaction is anomalous.

2. The computer-implemented method of claim 1, wherein the machine learning model is a quantum support vector machine running on a quantum computer, and the vectors are converted to qubits, wherein control signals indicating quantum operations to apply the qubits in training the quantum support vector machine are transmitted to control quantum hardware of the quantum computer.

3. The computer-implemented method of claim 2, further including:
receiving a new data sample;
transforming the new data sample into a covariance matrix;
transforming the covariance matrix into a vector by slimming the covariance matrix by removing redundant elements of the covariance matrix and flattening the slimmed covariance matrix into the vector; and
inputting the vector into the quantum computer for the trained quantum support vector machine to classify whether the new data sample is anomalous.

4. The computer-implemented method of claim 1, wherein responsive to determining that the set of training data includes unstructured data, the method further including:
encoding the unstructured data into numerical data prior to transforming the set of training data into covariance matrices.

5. The computer-implemented method of claim 1, wherein responsive to determining that the set of training data includes categorical data, the method further including:
encoding the categorical data into numerical data prior to transforming the set of training data into covariance matrices.

6. The computer-implemented method of claim 1, wherein the set of training data includes time series data, and the method includes sampling the set of training data over a time period, wherein the time period is a hyperparameter that is learned using a classical support vector machine and used in a pipeline for pre-processing the set of training data for training of a quantum support vector machine on a quantum computer.

7. The computer-implemented method of claim 1, wherein the slimming of the covariance matrices by removing redundant elements of the covariance matrices includes removing an upper half of the covariance matrices above diagonals of the covariance matrices.

8. The computer-implemented method of claim 1, wherein the slimming of the covariance matrices by removing redundant elements of the covariance matrices includes removing an upper half block of the covariance matrices.

9. The computer-implemented method of claim 1, wherein the slimming of the covariance matrices by removing redundant elements of the covariance matrices includes determining whether to remove the diagonals of the covariance matrices based on a hyperparameter that is learned using a classical support vector machine and used in a pipeline for pre-processing the set of training data for training of a quantum support vector machine on a quantum computer.

10. The computer-implemented method of claim 1, further including performing dimension reduction of the covariance matrices based on a hyperparameter that is learned using a classical support vector machine and used in a pipeline for pre-processing the set of training data for training of a quantum support vector machine on a quantum computer, the hyperparameter indicating whether the dimension reduction should be performed.

11. The computer-implemented method of claim 10, wherein another hyperparameter representing a number of dimensions to which the covariance matrices is to be reduced is learned using a classical support vector machine and used in a pipeline for pre-processing the set of training data for training of a quantum support vector machine on a quantum computer, the hyperparameter indicating whether the dimension reduction should be performed.

12. The computer-implemented method of claim 1, wherein the set of training data includes data associated with financial transactions.

13. A computer program product comprising a computer readable storage medium having program instructions embodied therewith, the program instructions readable by a device to cause the device to:
receive a set of training data for training a machine learning model to predict an anomalous transaction;
transform the set of training data into covariance matrices;
transform the covariance matrices into vectors by slimming the covariance matrices by removing redundant elements of the covariance matrices and flattening the slimmed covariance matrices into the vectors; and
input the vectors into the machine learning model, the machine learning model learning to predict whether a given transaction is anomalous.

14. The computer program product of claim 13, wherein the machine learning model is a quantum support vector machine running on a quantum computer, and the vectors are converted to qubits, wherein control signals indicating quantum operations to apply the qubits in training the quantum support vector machine are transmitted to control quantum hardware of the quantum computer.

15. The computer program product of claim 14, wherein the device is further caused to:
receive a new data sample;
transform the new data sample into a covariance matrix;
transform the covariance matrix into a vector by slimming the covariance matrix by removing redundant elements of the covariance matrix and flattening the slimmed covariance matrix into the vector; and
input the vector into the quantum computer for the trained quantum support vector machine to classify whether the new data sample is anomalous.

16. The computer program product of claim 13, wherein the set of training data includes time series data, and the device is caused to sample the set of training data over a time period, wherein the time period is a hyperparameter that is learned using a classical support vector machine and used in a pipeline for pre-processing the set of training data for training of a quantum support vector machine on a quantum computer.

17. The computer program product of claim 13, wherein the device is caused to remove an upper half of the covariance matrices above diagonals of the covariance matrices in slimming of the covariance matrices.

18. The computer program product of claim 13, wherein in slimming of the covariance matrices, the device is caused to determine whether to remove the diagonals of the covariance matrices based on a hyperparameter that is learned using a classical support vector machine and used in a pipeline for pre-processing the set of training data for training of a quantum support vector machine on a quantum computer.

19. A system comprising:
at least one computer processor;
at least one memory device coupled with the at least one computer processor;
the at least one computer processor configured to at least:
receive a set of training data for training a machine learning model to predict an anomalous transaction;
transform the set of training data into covariance matrices;
transform the covariance matrices into vectors by slimming the covariance matrices by removing redundant elements of the covariance matrices and flattening the slimmed covariance matrices into the vectors; and
input the vectors into the machine learning model, the machine learning model learning to predict whether a given transaction is anomalous.

20. The system of claim 19, wherein the system further includes a quantum computer coupled with the at least one computer processor, wherein machine learning model is a quantum support vector machine configured to run on the quantum computer, and the vectors are converted to qubits, wherein control signals indicating quantum operations to apply the qubits in training the quantum support vector machine are transmitted to control quantum hardware of the quantum computer.
